(19) United States
(12) Patent Application Publication
(10) Pub. No.: US 2018/0371644 A1
(43) Pub. Date: Dec. 27, 2018

(54) SELF-CURLING FILM, METHOD FOR MAKING THE SAME, AND METHOD FOR ACTIVATING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/638,818

(22) Filed: Jun. 30, 2017

(30) Foreign Application Priority Data
Jun. 23, 2017 (TW) 106120992

(51) Int. Cl. D01D 5/00; D04H 1/495; B29C 65/14

(52) U.S. Cl. CPC D01D 5/0046; D01D 5/0069; B82Y 40/00; B29C 65/1406; D04H 1/495

(57) ABSTRACT

A self-curling film includes a nanofiber base film and a nanofiber external film connected to the nanofiber base film. The nanofiber base film comprises a plurality of polymer nanofibers aligned according to a first single-direction aligning pattern. The nanofiber external film comprises a plurality of polymer nanofibers aligned according to a second aligning pattern that is the same as or different from the first aligning pattern. The polymer nanofibers of the nanofiber deformable film includes a temperature or UV-sensitive material that causes the nanofiber deformable film to shrink or expand when heated or exposed to ultraviolet radiation.

### FIELD

The subject matter herein generally relates to a self-curling film, a method for making the self-curling film, and a method for activating the self-curling film.

### BACKGROUND

Polymer materials have a good flexibility, and thus can be widely used in the manufacture of artificial blood vessels, artificial skins, robots, and sensors. However, many polymer materials such as plastic or rubber are not easily curled by an external stimulant, and the direction of curl and the degree of curl cannot be controlled. This limits applications of these kinds of polymer materials.

### BRIEF DESCRIPTION OF THE DRAWINGS

Implementations of the present technology will now be described, by way of example only, with reference to the attached figures.

FIG. 1 is a flowchart of an exemplary embodiment of a method for making a self-curling film.

FIG. 2 is a diagram of an electrospinning device used in the method in FIG. 1.

FIG. 3 is a diagram of a nanofiber base film made by the electrospinning device of FIG. 2.

FIG. 4 is a diagram showing a nanofiber deformable film formed on the nanofiber base film of FIG. 3, to form a nanofiber composite film.

FIG. 5 is a diagram showing the nanofiber composite film of FIG. 4 being cut to form a self-curling film.

FIG. 6 is a flowchart of an exemplary embodiment of a method for activating a self-curling film.

FIG. 7 is a diagram showing the self-curling film of FIG. 6 being heated, to form a sleeve.

FIG. 8 is a diagram showing the self-curling film of FIG. 6 under ultraviolet radiation, to form a sleeve.

FIG. 9 illustrates a reaction in the self-curling film of FIG. 8, when under ultraviolet radiation.

FIG. 10 is a diagram showing the alignment of the nanofiber base film and the nanofiber deformable film of nanofiber composite film of FIG. 5.

FIG. 11 is similar to FIG. 10, but showing the nanofiber base film and the nanofiber deformable film being aligned in a different way.

FIG. 12 is similar to FIG. 10, but showing the nanofiber base film and the nanofiber deformable film being aligned in yet another different way.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series, and the like.

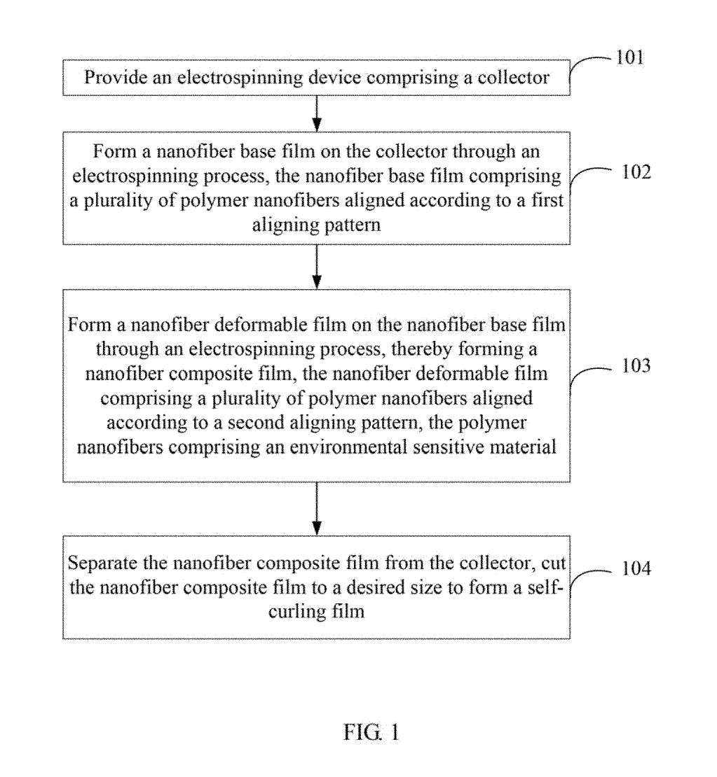

FIG. 1 illustrates a flowchart of an embodiment for a method for making a self-curling film. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 101.

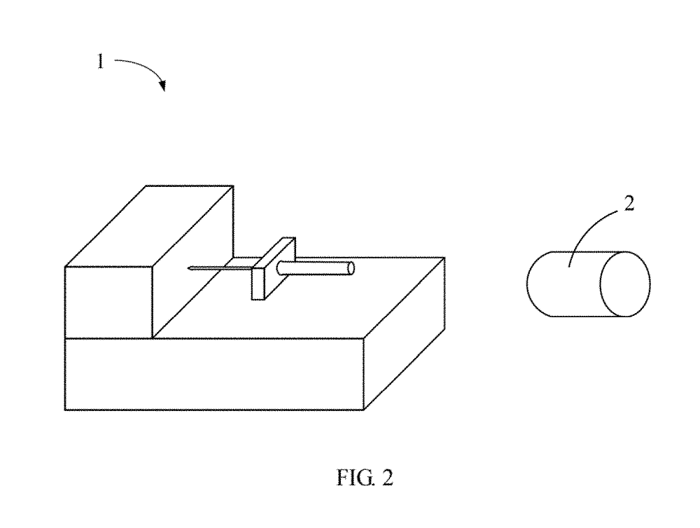

At block 101, referring to FIG. 2, an electrospinning device 1 is provided that comprises a collector 2.

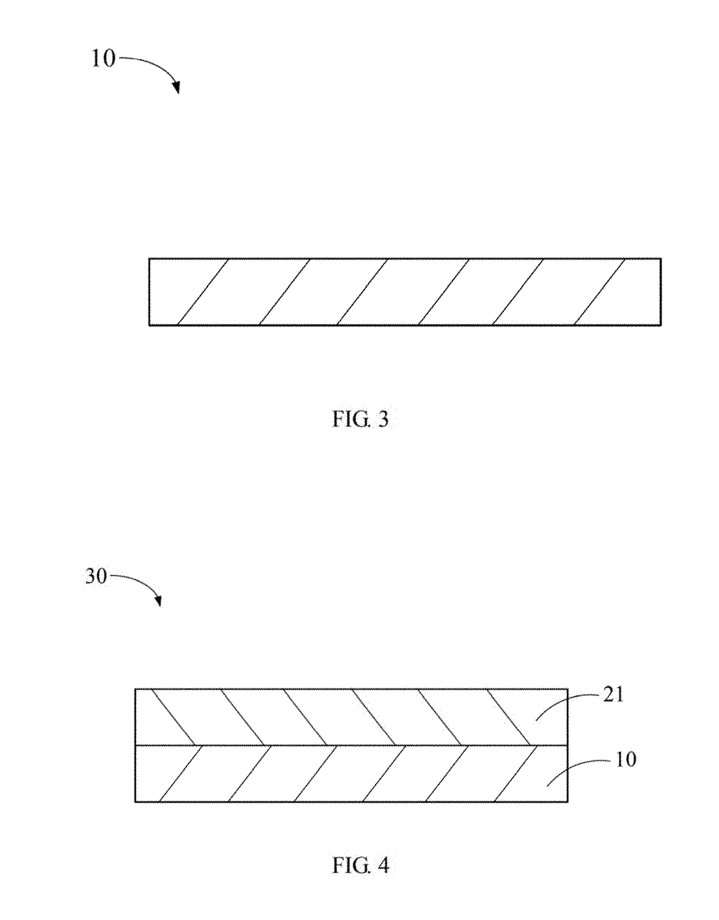

At block 102, referring to FIG. 3, a nanofiber base film 10 is formed on the collector 2 through an electrospinning process. The nanofiber base film 10 comprises a number of polymer nanofibers aligned according to a first aligning pattern. The first aligning pattern is that the polymer fibers of the nanofiber base film 10 are orderly aligned along a same direction.

At block 103, referring to FIG. 4, a nanofiber deformable film 21 is formed by an electrospinning process on a surface of the nanofiber base film 10 facing away from the collector 2, thereby forming a nanofiber composite film 30. The nanofiber deformable film 21 comprises a number of polymer nanofibers aligned according to a second aligning pattern that can be the same as or different from the first aligning pattern. The polymer nanofibers of the nanofiber deformable film 21 comprise a material that is sensitive to temperature changes or ultraviolet radiation (hereinafter, “environmental sensitive material”), so that the nanofiber deformable film 21 can shrink or expand when heated or exposed to ultraviolet radiation.

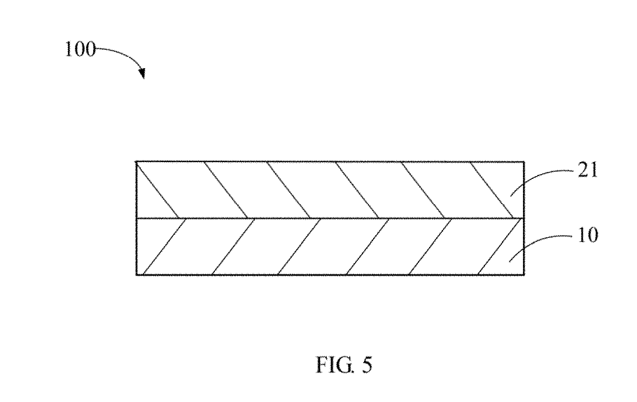

At block 104, referring to FIG. 5, the nanofiber composite film 30 is separated from the collector 2 and cut to a desired size, thereby forming the self-curling film 100.

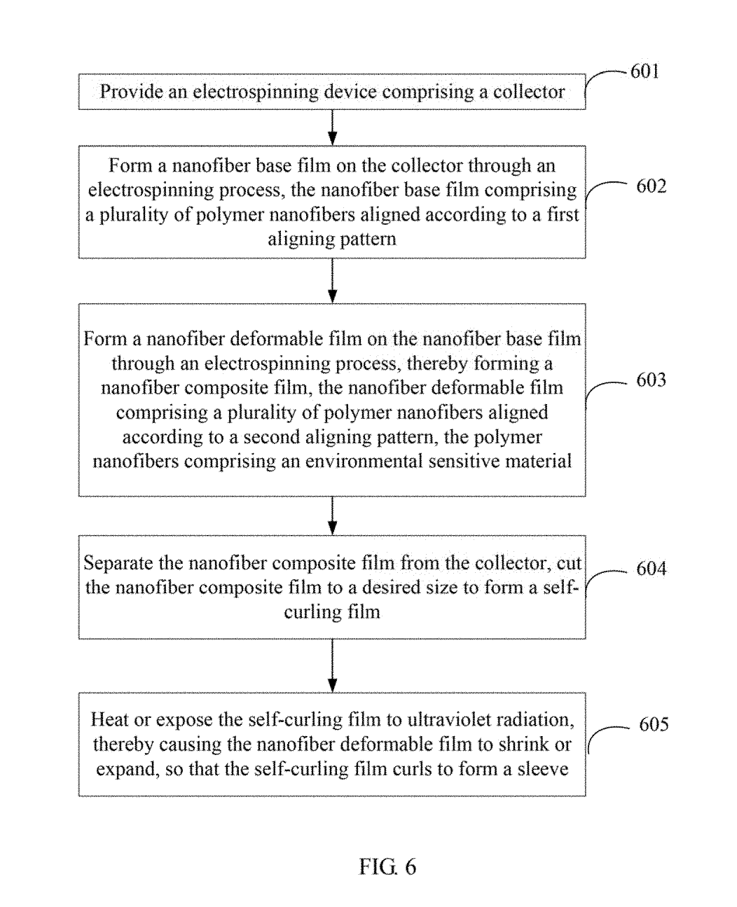

FIG. 6 illustrates a flowchart of an embodiment for a method for activating a self-curling film. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 601.

At block 601, referring to FIG. 2, an electrospinning device 1 is provided that comprises a collector 2.

At block 602, referring to FIG. 3, a nanofiber base film 10 is formed on the collector 2 through an electrospinning process. The nanofiber base film 10 comprises a number of polymer nanofibers aligned according to a first aligning pattern. The first aligning pattern is that the polymer fibers of the nanofiber base film 10 are orderly aligned along a same direction.

At block 603, referring to FIG. 4, a nanofiber deformable film 21 is formed by an electrospinning process on a surface of the nanofiber base film 10 facing away from the collector 2, thereby forming a nanofiber composite film 30. The nanofiber deformable film 21 comprises a number of polymer nanofibers aligned according to a second aligning pattern that can be the same as or different from the first aligning pattern. The polymer nanofibers of the nanofiber deformable film 21 comprise an environmental sensitive material that is sensitive to temperature changes or ultraviolet radiation, so that the nanofiber deformable film 21 can shrink or expand when heated or exposed to ultraviolet radiation.

At block 604, referring to FIG. 5, the nanofiber composite film 30 is separated from the collector 2 and cut to a desired size, thereby forming the self-curling film 100.

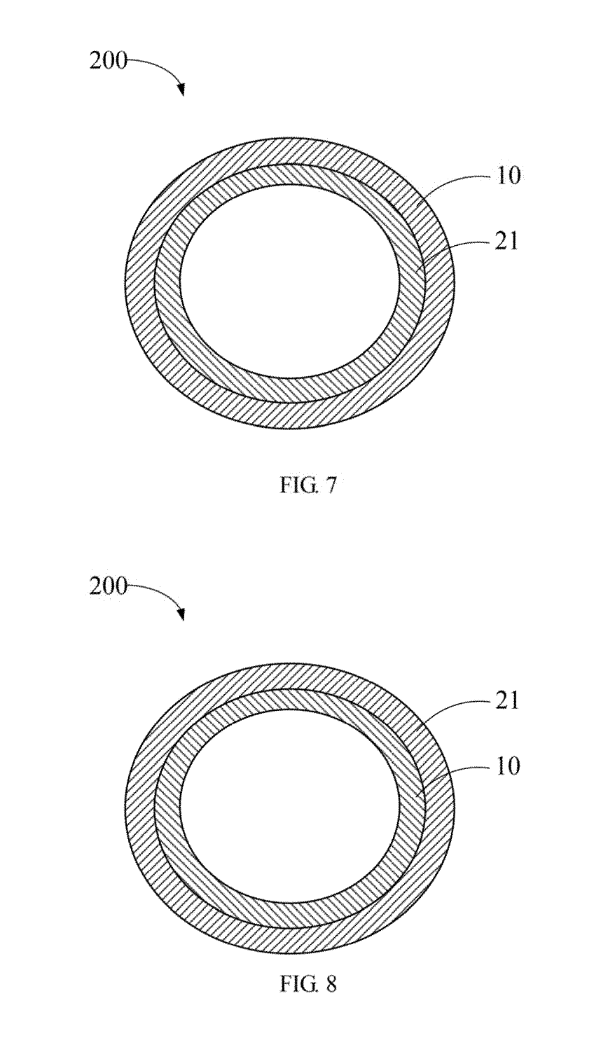

At block 605, referring to FIGS. 7 and 8, the self-curling film 100 is heated or exposed to ultraviolet radiation, thereby causing the nanofiber deformable film 21 to shrink (as shown in FIG. 7) or to expand (as shown in FIG. 8). Thus, the self-curling film 100 is curled to form a sleeve 200.

In at least one exemplary embodiment, the polymer nanofibers of the nanofiber base film 10 can comprise polyethylene glycol (PEG). The polymer nanofibers of the nanofiber deformable film 21 can comprise poly(N-isopropylacrylamide) (PNIPAAm). The PNIPAAm functions as the environmental sensitive material that can undergo a reversible phase transition when heated, thereby causing the nanofiber deformable film 21 to shrink. In this embodiment, the shrunk nanofiber deformable film 21 is positioned at an inner side of the sleeve (as shown in FIG. 7).

The nanofiber base film 10 can be formed by an electrospinning solution comprising PEG and a solvent. The nanofiber deformable film 21 can be formed by an electrospinning solution comprising PNIPAAm and a solvent. The solvent can be selected from a group consisting of formic acid, acetic acid, acetone, dimethylformamide, dimethylacetamide, etrahydrofuran, dimethyl sulfoxide, hexafluoroisopropanol, trifluoroethanol, dichloromethane, trichlormethane, methanol, ethanol, chlorotoluene, dioxane, trifluoroethane, trifluoroacetic acid, water, and any combination thereof.

In another exemplary embodiment, the polymer nanofibers of the nanofiber base film 10 can comprise polyurethane (PU) that has a high flexibility. The polymer nanofibers of the nanofiber deformable film 21 can comprise light-decomposable polymer. In this embodiment, the polymer nanofibers of the nanofiber deformable film 21 can comprise coumarin-containing PU. The coumarin has a chemical structure diagram of

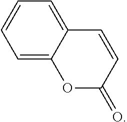 [SMILES: O=c1ccc2ccccc2o1]

The coumarin-containing PU has a chemical structure diagram of

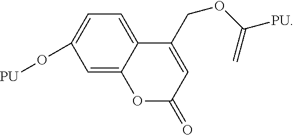

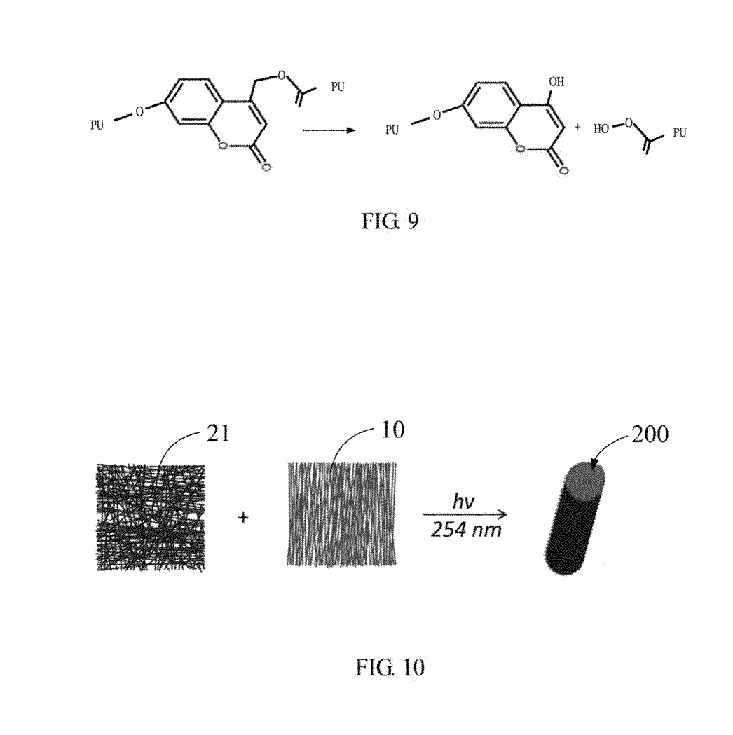

Referring to FIG. 9, the coumarin functions as the environmental sensitive material that can decompose under the ultraviolet radiation, thereby causing the nanofiber deformable film 21 to expand. In this embodiment, the expanded nanofiber deformable film 21 is positioned at an outer side of the sleeve (as shown in FIG. 8).

The nanofiber base film 10 can be formed by an electrospinning solution comprising PU and a solvent. The nanofiber deformable film 21 can be formed by an electrospinning solution comprising coumarin-containing PU and a solvent. The solvent can be selected from a group consisting of formic acid, acetic acid, acetone, dimethylformamide, dimethylacetamide, etrahydrofuran, dimethyl sulfoxide, hexafluoroisopropanol, trifluoroethanol, dichloromethane, trichlormethane, methanol, ethanol, chlorotoluene, dioxane, trifluoroethane, trifluoroacetic acid, water, and any combination thereof.

Referring to FIG. 10, in at least one exemplary embodiment, the first aligning pattern is that the polymer fibers of the nanofiber base film 10 are orderly aligned along a same direction. The second aligning pattern is that the polymer fibers of the nanofiber deformable film 21 are randomly aligned.

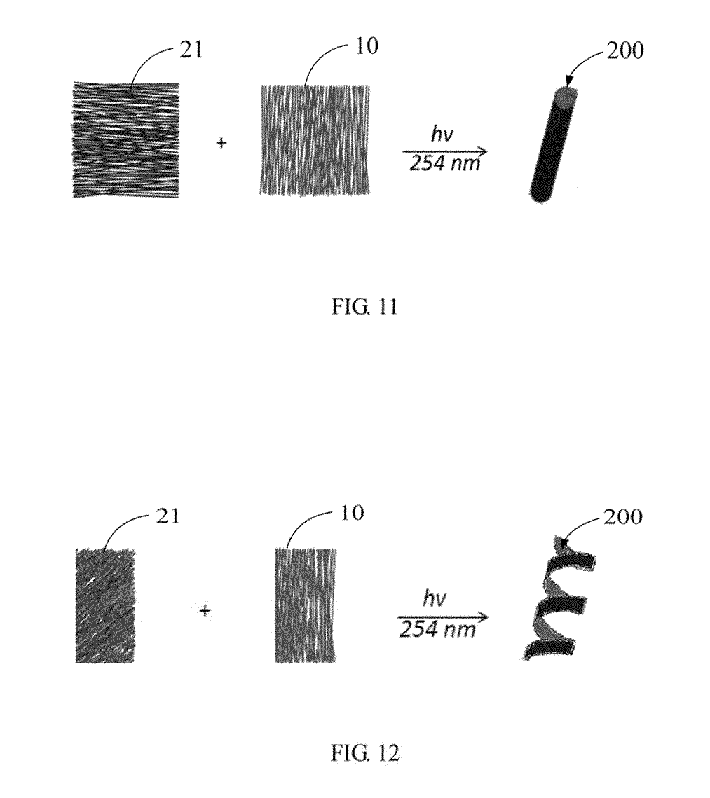

Referring to FIG. 11, in another exemplary embodiment, the first aligning pattern is that the polymer fibers of the nanofiber base film 10 are orderly aligned along a first direction (lengthways direction). The second aligning pattern is that the polymer fibers of the nanofiber deformable film 21 are orderly aligned along a second direction (crossways direction) that is perpendicular to the first direction.

Referring to FIG. 12, in other embodiments, the first aligning pattern is that the polymer fibers of the nanofiber base film 10 are orderly aligned along a first direction (lengthways direction). The second aligning pattern is that the polymer fibers of the nanofiber deformable film 21 are orderly aligned along a second direction that is parallel to the first direction or oblique to the first direction.

The aligning pattern of the polymer nanofibers can be controlled by adjusting the rotating speed of the collector 2. For example, the polymer nanofibers are randomly aligned when the rotating speed of the collector 2 is 100 rpm. The polymer nanofibers are orderly aligned when the rotating speed of the collector 2 is 1500 rpm. Furthermore, the thicknesses and densities of the nanofiber base film 10 and the nanofiber deformable film 21 can be controlled by adjusting the collecting time period of the collector 2. In at least one exemplary embodiment, each of the nanofiber base film 10 and the nanofiber deformable film 21 has a thickness of about 50 μm.

The electrospinning process can be used to precisely control the aligning direction of the polymer nanofibers of the nanofiber base film 10 and the nanofiber deformable film 21. Furthermore, when the polymer nanofibers of the nanofiber base film 10 are controlled for alignment along the same direction, the curling direction of the nanofiber deformable film 21 can be controlled. Also, the desired degree of curling the nanofiber deformable film 21 (that is, the desired degree of curling the sleeve 200) is affected by the aligning pattern of the polymer nanofibers of the nanofiber deformable film 21.

In detail, when the nanofiber deformable film 21 curls under heat or under the ultraviolet radiation, the edges of the nanofiber deformable film 21 that are parallel to the aligning direction of the polymer nanofibers of the nanofiber base film 10 are resistant to curling. The edges of the nanofiber deformable film 21 that are perpendicular to the aligning direction of the polymer nanofibers of the nanofiber base film 10 are less resistant to curling. That is, the curling direction of the nanofiber deformable film 21 should be perpendicular to the aligning direction of the polymer nanofibers of the nanofiber base film 10. Specifically, when the polymer fibers of the nanofiber deformable film 21 are orderly aligned along a second direction that is inclined to the first direction by 45 degrees, the self-curling film 100 can curl to form a spiral sleeve 200.

Moreover, when the polymer fibers of the nanofiber base film 10 are randomly aligned, the nanofiber deformable film 21 has no directional resistance to curling, or preferred curling direction.

### Example 1

A nanofiber base film 10 was formed when the rotating speed of the collector 2 was 100 rpm and the collecting time period of the collector 2 was 1 h. The nanofiber base film 10 comprised polymer nanofibers randomly aligned. A nanofiber deformable film 21 was formed on the nanofiber base film 10 to form a nanofiber composite film 30 when the rotating speed of the collector 2 was 100 rpm and the collecting time period of the collector 2 was 45 minutes. The nanofiber base film 10 comprised polymer nanofibers randomly aligned. The nanofiber composite film 30 was separated from the collector 2 and cut to 1×1 cm² to form a self-curling film 100. The self-curling film 100 was then exposed to ultraviolet radiation of 254 nm. The self-curling film 100 curled but had no specific curling direction.

### Example 2

A nanofiber base film 10 was formed when the rotating speed of the collector 2 was 1500 rpm and the collecting time period of the collector 2 was 1 h. The nanofiber base film 10 comprised polymer nanofibers orderly aligned along a same direction. A nanofiber deformable film 21 was formed on the nanofiber base film 10 to form a nanofiber composite film 30 when the rotating speed of the collector 2 was 100 rpm and the collecting time period of the collector 2 was 45 minutes. The nanofiber base film 10 comprised polymer nanofibers randomly aligned. The nanofiber composite film 30 was separated from the collector 2 and cut to 1×1 cm² to form a self-curling film 100. The self-curling film 100 was then exposed to ultraviolet radiation of 254 nm. The self-curling film 100 curled to form a sleeve 200 that had a diameter of 3 mm and a length of 1 cm.

### Example 3

A nanofiber base film 10 was formed when the rotating speed of the collector 2 was 1500 rpm and the collecting time period of the collector 2 was 1 h. The nanofiber base film 10 comprised polymer nanofibers orderly aligned along a first direction. The collector 2 was rotated about 90 degrees. A nanofiber deformable film 21 was formed on the nanofiber base film 10 to form a nanofiber composite film 30 when the rotating speed of the collector 2 was 1500 rpm and the collecting time period of the collector 2 was 1 h. The nanofiber base film 10 comprised polymer nanofibers orderly aligned along a second direction perpendicular to the first direction. The nanofiber composite film 30 was separated from the collector 2 and cut to 1×1 cm² to form a self-curling film 100. The self-curling film 100 and was then exposed to ultraviolet radiation of 254 nm. The self-curling film 100 curled to form a sleeve 200 that had a diameter of 2 mm and a length of 1 cm.

### Example 4

A nanofiber base film 10 was formed when the rotating speed of the collector 2 was 1500 rpm and the collecting time period of the collector 2 was 1 h. The nanofiber base film 10 comprised polymer nanofibers orderly aligned along a first direction. The collector 2 was rotated about 45 degrees. A nanofiber deformable film 21 was formed on the nanofiber base film 10 to form a nanofiber composite film 30 when the rotating speed of the collector 2 was 1500 rpm and the collecting time period of the collector 2 was 1 h. The nanofiber base film 10 comprised polymer nanofibers orderly aligned along a second direction that was inclined to the first direction by 45 degrees. The nanofiber composite film 30 was separated from the collector 2 and cut to 2×0.5 cm² to form a self-curling film 100. The self-curling film 100 and was then exposed to ultraviolet radiation of 254 nm. The self-curling film 100 curled to form a spiral sleeve 200.

FIG. 5 illustrates an exemplary embodiment of a self-curling film 100. The self-curling film 100 comprises a nanofiber base film 10 and a nanofiber deformable film 21 connected to the nanofiber base film 10.

The nanofiber base film 10 comprises a number of polymer nanofibers aligned according to a first aligning pattern. The first aligning pattern is that the polymer fibers of the nanofiber base film 10 are orderly aligned along a same direction. The nanofiber deformable film 21 comprises a number of polymer nanofibers aligned according to a second aligning pattern that is the same as or different from the first aligning pattern. The polymer nanofibers of the nanofiber deformable film 21 comprise an environmental sensitive material that is sensitive to temperature or ultraviolet radiation, so that the nanofiber deformable film 21 can shrink or expand when heated or exposed to ultraviolet radiation.

In at least one exemplary embodiment, the polymer nanofibers of the nanofiber base film 10 can comprise polyethylene glycol (PEG). The polymer nanofibers of the nanofiber deformable film 21 can comprise poly(N-isopropylacrylamide) (PNIPAAm). The PNIPAAm functions as the environmental sensitive material that can undergo a reversible phase transition when heat, thereby causing the nanofiber deformable film 21 to shrink.

In another exemplary embodiment, the polymer nanofibers of the nanofiber base film 10 can comprise polyurethane (PU) that has a high flexibility. The polymer nanofibers of the nanofiber deformable film 21 can comprise light-decomposable polymer. In this embodiment, the polymer nanofibers of the nanofiber deformable film 21 can comprise coumarin-containing PU. Coumarin functions as the environmental sensitive material that can decompose under the ultraviolet radiation, thereby causing the nanofiber deformable film 21 to expand.

With the above configuration, since the nanofiber deformable film 21 comprises an environmental sensitive material, the nanofiber deformable film 21 can shrink or expand. The shrinking or the expanding forms the sleeve 200, to obtain a desired shape and a desired degree of curling. Furthermore, the curling direction of the nanofiber deformable film 21 can be controlled by controlling the polymer nanofibers of the nanofiber base film 10 to be aligned along the same direction. The desired degree of curling the nanofiber deformable film 21 can be controlled by controlling the aligning pattern of the polymer nanofibers of the nanofiber deformable film 21. Moreover, the nanofiber composite film 30 can be cut according to a desired size of the sleeve 200. Thus, the size of the sleeve 200 can be precisely controlled to satisfy different users.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for making a self-curling film comprising:
providing an electrospinning device comprising a collector;
forming a nanofiber base film on the collector through an electrospinning process, the nanofiber base film comprising a plurality of polymer nanofibers aligned according to a first aligning pattern, wherein the first aligning pattern is that the polymer fibers of the nanofiber base film are orderly aligned along a same direction;
forming a nanofiber deformable film on a surface of the nanofiber base film facing away from the collector through an electrospinning process, thereby forming a nanofiber composite film, the nanofiber deformable film comprising a plurality of polymer nanofibers aligned according to a second aligning pattern that is the same as or different from the first aligning pattern, the polymer nanofibers of the nanofiber deformable film comprising an environmental sensitive material that is sensitive to temperature changes or ultraviolet radiation, thereby causing the nanofiber deformable film to shrink or expand when heated or exposed to ultraviolet radiation; and
separating the nanofiber composite film from the collector and cutting the nanofiber composite film to a desired size, thereby forming the self-curling film.

2. The method of claim 1, wherein the polymer nanofibers of the nanofiber base film comprise polyethylene glycol, the polymer nanofibers of the nanofiber deformable film comprise poly(N-isopropylacrylamide), and the poly(N-isopropylacrylamide) functions as the environmental sensitive material.

3. The method of claim 2, wherein the nanofiber base film is formed by an electrospinning solution comprising polyethylene glycol and a solvent, and the nanofiber deformable film is formed by an electrospinning solution comprising poly(N-isopropylacrylamide) and a solvent.

4. The method of claim 3, wherein the solvent is selected from a group consisting of formic acid, acetic acid, acetone, dimethylformamide, dimethylacetamide, etrahydrofuran, dimethyl sulfoxide, hexafluoroisopropanol, trifluoroethanol, dichloromethane, trichlormethane, methanol, ethanol, chlorotoluene, dioxane, trifluoroethane, trifluoroacetic acid, water, and any combination thereof.

5. The method of claim 1, wherein the polymer nanofibers of the nanofiber base film comprise polyurethane, the polymer nanofibers of the nanofiber deformable film comprise light-decomposable polymer.

6. The method of claim 5, wherein the light-decomposable polymer is coumarin-containing polyurethane, and coumarin functions as the environmental sensitive material.

7. The method of claim 6, wherein the nanofiber base film is formed by an electrospinning solution comprising polyurethane and a solvent, and the nanofiber deformable film is formed by an electrospinning solution comprising coumarin-containing polyurethane and a solvent.

8. The method of claim 7, wherein the solvent is selected from a group consisting of formic acid, acetic acid, acetone, dimethylformamide, dimethylacetamide, etrahydrofuran, dimethyl sulfoxide, hexafluoroisopropanol, trifluoroethanol, dichloromethane, trichlormethane, methanol, ethanol, chlorotoluene, dioxane, trifluoroethane, trifluoroacetic acid, water, and any combination thereof.

9. A method for activating a self-curling film comprising:
providing an electrospinning device comprising a collector;
forming a nanofiber base film on the collector through an electrospinning process, the nanofiber base film comprising a plurality of polymer nanofibers aligned according to a first aligning pattern, wherein the first aligning pattern is that the polymer fibers of the nanofiber base film are orderly aligned along a same direction;
forming a nanofiber deformable film on a surface of the nanofiber base film facing away from the collector through an electrospinning process, thereby forming a nanofiber composite film, the nanofiber deformable film comprising a plurality of polymer nanofibers aligned according to a second aligning pattern that is the same as or different from the first aligning pattern, the polymer nanofibers of the nanofiber deformable film comprising an environmental sensitive material that is sensitive to temperature changes or ultraviolet radiation, thereby causing the nanofiber deformable film to shrink or expand when heated or exposed to ultraviolet radiation;
separating the nanofiber composite film from the collector and cutting the nanofiber composite film to a desired size, thereby forming the self-curling film; and
heating or exposing the self-curling film to ultraviolet radiation, thereby causing the nanofiber deformable film to shrink or expand, so that the self-curling film curls to form a sleeve.

10. The method of claim 9, wherein the polymer nanofibers of the nanofiber base film comprise polyethylene glycol, the polymer nanofibers of the nanofiber deformable film comprise poly(N-isopropylacrylamide), and the poly(N-isopropylacrylamide) functions as the environmental sensitive material.

11. The method of claim 9, wherein the polymer nanofibers of the nanofiber base film comprise polyurethane, the polymer nanofibers of the nanofiber deformable film comprise light-decomposable polymer.

12. The method of claim 11, wherein the light-decomposable polymer is coumarin-containing polyurethane, and coumarin functions as the environmental sensitive material.

13. The method of claim 12, wherein the second aligning pattern is that the polymer fibers of the nanofiber deformable film are randomly aligned.

14. The method of claim 12, wherein the first aligning pattern is that the polymer fibers of the nanofiber base film are orderly aligned along a first direction, and the second aligning pattern is that the polymer fibers of the nanofiber deformable film are orderly aligned along a second direction that is perpendicular to the first direction.

15. The method of claim 12, wherein the first aligning pattern is that the polymer fibers of the nanofiber base film are orderly aligned along a first direction, and the second aligning pattern is that the polymer fibers of the nanofiber deformable film are orderly aligned along a second direction that is inclined to the first direction by 45 degrees.

16. A self-curling film comprising:
a nanofiber base film comprising a plurality of polymer nanofibers aligned according to a first aligning pattern, wherein the first aligning pattern is that the polymer fibers of the nanofiber base film are orderly aligned along a same direction; and
a nanofiber deformable film connected to the nanofiber base film, the nanofiber deformable film comprising a plurality of polymer nanofibers aligned according to a second aligning pattern that is the same as or different from the first aligning pattern, the polymer nanofibers of the nanofiber deformable film comprising an environmental sensitive material that is sensitive to temperature changes or ultraviolet radiation, thereby causing the nanofiber deformable film to shrink or expand when heated or exposed to ultraviolet radiation.

17. The self-curling film of claim 16, wherein the polymer nanofibers of the nanofiber base film comprise polyethylene glycol, the polymer nanofibers of the nanofiber deformable film comprise poly(N-isopropylacrylamide), and the poly(N-isopropylacrylamide) functions as the environmental sensitive material.

18. The self-curling film of claim 16, wherein the polymer nanofibers of the nanofiber base film comprise polyurethane, the polymer nanofibers of the nanofiber deformable film comprise light-decomposable polymer.

19. The self-curling film of claim 18, wherein the light-decomposable polymer is coumarin-containing polyurethane, and coumarin functions as the environmental sensitive material.
